(19) United States
(12) Patent Application Publication
(10) Pub. No.: US 2007/0277038 A1
(43) Pub. Date: Nov. 29, 2007

(54) Method for authentication of software within a product

(75) Inventors: Douglas A. Hardy, Scottsdale, AZ (US); Kenneth J. Welling, Mesa, AZ (US); Richard B. Asen, Woodstock, MD (US)

Correspondence Address: MESCHKOW & GRESHAM, P.L.C., 5727 NORTH SEVENTH STREET, SUITE 409, PHOENIX, AZ, 85014, US

(73) Assignee: General Dynamics C4 Systems, Inc.

(21) Appl. No.: 11/442,448

(22) Filed: May 25, 2006

(51) Int. Cl. H04L 9/00; G06F 12/14; H04L 9/32; G06F 11/30

(52) U.S. Cl. 713/176; 713/189

(57) ABSTRACT

Authentication management of software (22) in a product (28) encompasses trust anchor assignment (66) and trust anchor verification (68). A root public key (40) of a root trust anchor (32) is stored (80) in non-changeable memory (54) in the product (28). A signed operational public key (86) is formed by attaching a root signature (84) to an operational public key (44) of an operational trust anchor (34) using a root private key (38). An operational signature (96) is appended to the software (22) using an operational private key. (42) to form signed software (98). The signed operational public key (86) and the signed software (98) are saved in changeable memory (56) in the product (28). Upon verification of the root signature (84) utilizing the root public key (40) and validation of the operational signature (96) using the operational public key (44), the software (22) is authenticated and enabled to execute.

### GOVERNMENT RIGHTS

This invention was made with Government support under Contract No. MDA 904-03-C-0997/0000 awarded by the National Security Agency. The Government has certain rights in this invention.

### TECHNICAL FIELD OF THE INVENTION

The present invention relates to the field of computer software security. More specifically, the present invention relates to a method for authenticating software in a product prior to software execution.

### BACKGROUND OF THE INVENTION

Security has become a critical feature in computing products, such as workstations, microprocessors, embedded systems, communications systems, and the like. One area of vulnerability lies with the authentication of software loaded into such computing products. Software can be loaded into a computing product by physically inserting a non-volatile storage medium, such as a diskette, optical disk, and the like, into a local drive associated with the computing product. In addition, software is increasingly being downloaded over computer networks. Unfortunately, this software and data can be intercepted or modified in transit between systems, such as between a software developer and the computing product. The software may also be modified following installation through a deliberate act by an unauthorized individual, or through an accidental system malfunction. In such cases, the software can no longer be presumed to operate correctly.

Various techniques have been employed to attempt to ensure that software loaded onto a product has been certified as authentic by the product's developers prior to executing the software. One typical technique is through public key cryptography. As known to those skilled in the art, public key cryptography is an asymmetric scheme which generally allows users to communicate securely using a pair of keys, designated as a public key, which encrypts data, and a corresponding private key, which decrypts data.

Public key cryptography also provides a method for employing digital signatures. A digital signature enables the recipient of information to verify the authenticity of the information's origin, and also verify that the information is intact. Thus, public key digital signatures provide authentication and data integrity. A digital signature also provides non-repudiation, meaning that it prevents the sender from claiming that he or she did not actually send the information.

Through public key cryptography, a trusted, or certification, authority “signs” the software. That is, the trusted authority applies a digital signature to the software, using the trusted authority's private key. The computing product subsequently verifies this signature using the trusted authority's public key prior to executing the software.

The trusted authority's signature public/private key pair is known as a trust anchor. In traditional implementations, the public key of the trust anchor is hard coded into a computing product in a way that prevents it from being changed. This hard coding provides a very high level of confidence that the trust anchor public key is valid, and therefore the software authenticated by the trust anchor public key is also valid.

The use of a single trust anchor for all products and for all time is not desirable and has security disadvantages. For example, a trust anchor public key that is resistant to current methods of attack might nevertheless become an object of attack at some future date. By way of another example, a security incident at the trusted authority might compromise the trust anchor private key. Consequently, it is highly desirable to change the trust anchor from time to time and from product to product. Unfortunately, in a product having a trust anchor hard coded onto a chip, the chip must be replaced in order to change the trust anchor. Such hardware modifications are expensive and problematic in terms of logistical control.

Other implementations store the trust anchors in a programmable/changeable memory location. Such implementations require the addition of physical tamper mechanisms to protect the trust anchor from modification. The ability to change the trust anchor creates a security vulnerability in that if the trust anchor can be changed, it can no longer be fully trusted. Therefore, the software that the trust anchor verifies can no longer be fully trusted. Unfortunately, with a changeable trust anchor, the authentication of the software is only as strong as the physical mechanisms that protect access to the trust anchor.

Thus, what is needed is a technique that permits a trust anchor to be changed, while concurrently retaining the assurance provided by a hard coded trust anchor.

### SUMMARY OF THE INVENTION

Accordingly, it is an advantage of the present invention that a method for authentication of software in a product is provided.

It is another advantage of the present invention that a method is provided that enables a trust anchor to be changed while concurrently retaining assurance of software integrity.

Another advantage of the present invention is that a method is provided that prevents unauthenticated software from executing.

The above and other advantages of the present invention are carried out in one form by a method for authentication of software installed in a product. The method calls for storing a first public component of a first trust anchor in non-changeable memory within the product. A first signature is attached to a second public component of a second trust anchor using a first private component of the first trust anchor. The second public component with the attached first signature is loaded in changeable memory within the product. A second signature is appended to the software using a second private component of the second trust anchor, and the software with the appended second signature is saved in the changeable memory within the product. The first public component is utilized to verify the first signature, and upon verification of the first signature, the software is authenticated by using the second public component to validate the second signature.

The above and other advantages of the present invention are carried out in another form by a system within a product for authenticating executable software. The system includes non-changeable memory for storing a first public component of a first trust anchor and a first changeable memory portion for storing a second public component of a second trust anchor. The second public component has an attached first signature, the first signature being derived using a first private component of the first trust anchor. The system further includes a second changeable memory portion for storing the software having an appended second signature, the second signature being derived using a second private component of the second trust anchor. A processor is in communication with each of the non-changeable memory, the first changeable memory portion, and the second changeable memory portion. The processor utilizes the first public component to verify the first signature and uses the second public component to validate the second signature. The processor further prevents execution of the software upon invalidation of either of the first and second signatures.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a block diagram of an arrangement in which authentication management of software may be deployed in accordance with a preferred embodiment of the present invention;

FIG. 2 shows a chart of an authentication management scheme performed within the arrangement of FIG. 1;

FIG. 3 shows a flowchart of a trust anchor assignment process;

FIG. 4 shows a flowchart of a trust anchor verification process; and

FIG. 5 shows a block diagram of an authentication management system in accordance with an alternative embodiment of the present invention.

### DETAILED DESCRIPTION OF THE PREFERRED EMBODIMENTS

The present invention involves a method and system for authenticating software installed in a computing product, such as a workstation, embedded system, communication system, and the like. It should become apparent that the methodology can be readily implemented into various products, each having programmable, executable software for which the software developer desires authentication prior to execution. The term “software” used herein refers to that part of a computing product that includes encoded information (or instructions), as opposed to the physical computing equipment (hardware) which is used to store and process this encoded information.

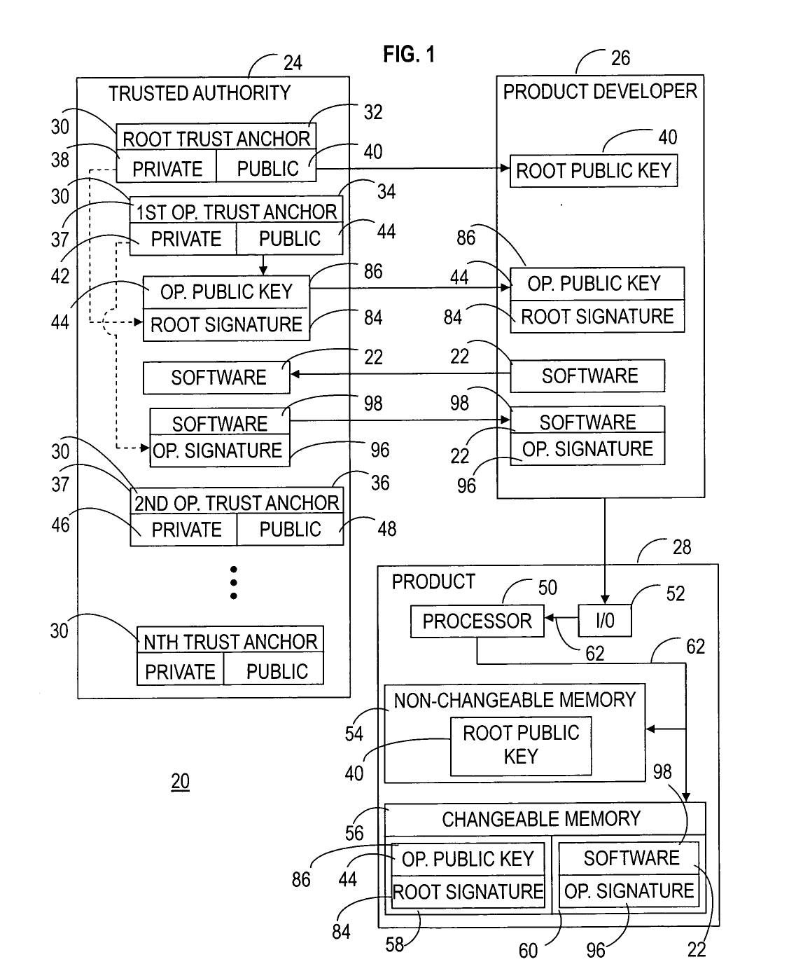

FIG. 1 shows a block diagram of an arrangement 20 in which authentication management of software 22 may be deployed in accordance with a preferred embodiment of the present invention. Arrangement 20 includes a trusted authority 24 in communication with a product developer 26, who is developing a product 28 and/or software 22 to be installed into product 28. Trusted authority 24 is an entity which produces and shares public and private cryptography key pairs, collectively referred to herein as trust anchors 30.

In accordance with the present invention, trusted authority 24 produces and shares a plurality of trust anchors 30. Some trust anchors 30 may be utilized as root trust anchors. The term “root trust anchor” refers to one of trust anchors 30 that is hard coded into product 28 and is permanent for the life of product 28, and the term “operational trust anchor” refers to one of trust anchors 30 that is loaded into product 28, but can be replaced as needed.

For purposes of the following description, trust anchors 30 include a first trust anchor (referred to herein as a root trust anchor 32), a second trust anchor (referred to herein as a first operational trust anchor 34), and a third trust anchor (referred to herein as a second operational trust anchor 36). First and second operational trust anchors 34 and 36, respectively, are collectively referred to herein as operational trust anchors 37. The remaining plurality of trust anchors 30 are not distinguished for brevity, but can be other root and/or operational trust anchors.

Root trust anchor 32 is a cryptographic key pair that includes a first private component, i.e., a root private key 38, and a first public component, i.e., a root public key 40. Similarly, first operational trust anchor 34 includes a second private component, i.e., an operational private key 42, and a second public component, i.e., an operational public key 44. Likewise, second operational trust anchor 36 includes a third private component, i.e., an operational private key 46, and a third public component, i.e., an operational public key 48. Similarly, remaining trust anchors 30 have private and public components that are not distinguished for brevity.

Product 28 includes a processor 50 on which software authentication in accordance with the present invention can be practiced. Processor 50 is in communication with an input/output element 52, a non-changeable memory element 54, and a changeable memory element 56 having a first portion 58 and a second portion 60. These elements are interconnected by a bus structure 62. Product 28 may include various other components (not shown) for carrying out the particular work for which product 28 is designed. In addition, the elements that provide a system for software authentication in product 28 may serve additional other purposes, not critical to understanding the present invention.

Input/output element 52 provides external path means for enabling communication between product 28 and components operated by product developer 26. For example, input/output element 52 may be a port, such as a Universal Serial Bus (USB) port, for cabled attachment to a corresponding port on a computing system operated by developer 26.

Non-changeable memory 54 is a storage medium, such as read-only memory (ROM), whose contents can be accessed and read, but cannot be changed. Non-changeable memory 54 may be loaded with data and programs by product developer 26 during manufacture and can subsequently only be read, not written to, by processor 50. The contents of non-changeable memory 54 are not lost when the power is switched off. Changeable memory 56 may be an external or internal non-volatile storage medium such as flash memory, magnetic computer storage device, optical disk, erasable programmable read-only memory (EPROM), and the like. Changeable memory 56 may be loaded with programs and data during manufacture and may later be erased and re-loaded with new and/or updated programs and data.

In general, arrangement 20 provides methodology, discussed below, for utilizing multiple trust anchors 30 to assure the integrity of software 22 installed within product 28, while further enabling trust anchors 30 to be replaced as needed. As such, root public key 40 of root trust anchor 32 is hard coded into product 28 in non-changeable memory 54, and one of operational trust anchors 37, in this case operational public key 44 of first operational trust anchor 34, is loaded into first portion 58 of changeable memory 56 and can be replaced as needed.

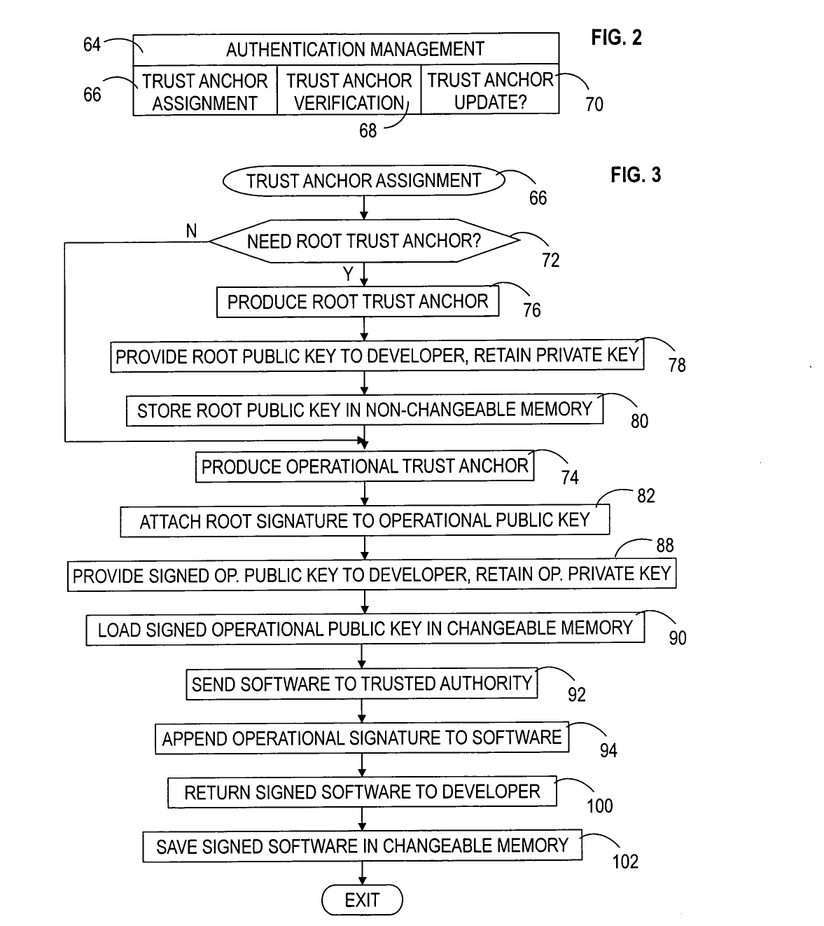

Referring to FIG. 2 in connection with FIG. 1, FIG. 2 shows a chart of an authentication management scheme 64 performed within arrangement 20. In general, authentication management scheme 64 provides for assignment of trust anchors 30 to software 22 and their subsequent verification prior to executing software 22 within product 28. Authentication management scheme 64, with its associated constituents, is cooperatively performed by trusted authority 24, product developer 26, and product 28 within arrangement 20 to assure the integrity of software 22 within product 28. Of course, scheme 64 may be implemented for a plurality of computing products developed and/or programmed by product developer 26 and/or various other product developers that are associated with trusted authority 24.

Accordingly, authentication management scheme 64 includes a trust anchor assignment process 66 to associate, for example, root trust anchor 32 and one of operational trust anchors 37 with software 22. The details of trust anchor assignment process 66 are provided in connection with FIG. 3.

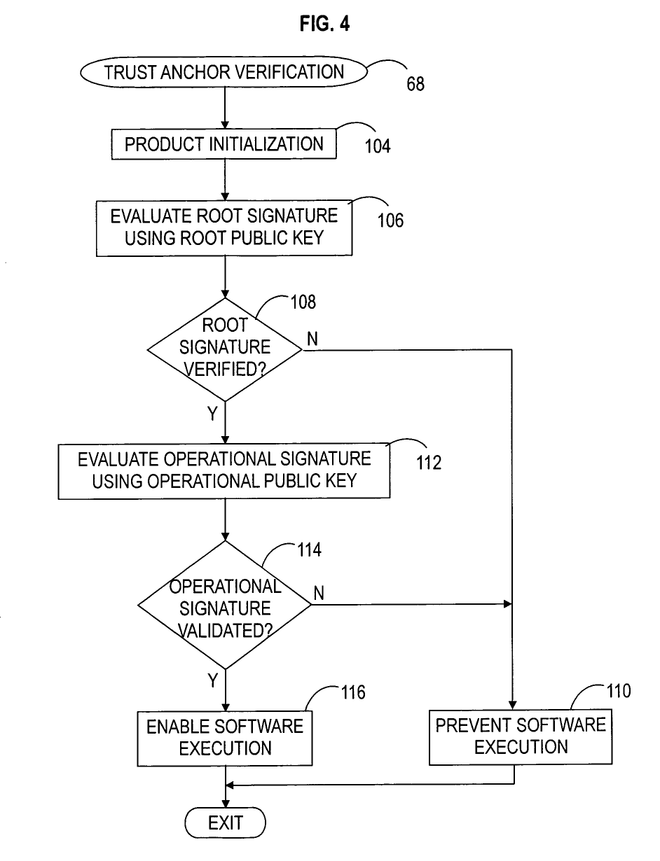

Authentication management scheme 64 further includes a trust anchor verification process 68, to verify the association of root trust anchor 32 and one of operational trust anchors 37 with software 22 prior to execution of software 22 within product 28. The details of trust anchor verification process 68 are provided in connection with FIG. 4.

Authentication management scheme 64 also includes an operational trust anchor update process 70. In this simplistic illustration, process 70 may entail a decision based operation in which a determination is made as to whether the one of operational trust anchors 37 currently associated with software 22 is to be updated. Product developer 26 may determine a necessity for replacing the current one of operational trust anchors 37 with another one of operational trust anchors 37, in response to security attacks on product 28, updates to software 22, security breech at trusted authority 24, and so forth.

When the current one of operational trust anchors 37, e.g., first operational trust anchor 34, is to be updated, authentication management scheme 64 repeats trust anchor assignment process 66. Trust anchor verification process 68 is thus performed prior to executing software 22 utilizing the updated one of operational trust anchors 37. However, when the current one of operational trust anchors 37 is not to be updated, trust anchor verification process 68 is performed prior to executing software 22 utilizing the currently assigned one of operational trust anchors 37. Knowledge of the association of root trust anchor 32 and the current operational trust anchor 37 with software 22 may be maintained by trusted authority 24, product developer 26, and within product 28.

Now referring to FIGS. 1 and 3, FIG. 3 shows a flowchart of trust anchor assignment process 66. Trust anchor assignment process 66 is performed to associate root trust anchor 32 and one of operational trust anchors 37 with software 22.

Trust anchor assignment process 66 begins with a query task 72. Query task 72 determines whether one of trust anchors 30 is needed as root trust anchor 32. Query task 72 of trust anchor assignment process 66 serves to distinguish the assignment of multiple trust anchors 30 that occurs at the development stage of product 28 and/or software 22 from an update request for a new one of operational trust anchors 37. Such a determination may be responsive to a request from product developer 26.

When query task 72 determines that root trust anchor 32 is not needed, process control 66 proceeds to a task 74 to enable an update of the current one of operational trust anchors 37, discussed below. However, when query task 72 determines that root trust anchor 32 is needed, trust anchor assignment process 66 proceeds to a task 76.

At task 76, trusted authority 24 produces root trust anchor 32. Trusted authority 24 may generate root trust anchor 32 using a key generation algorithm, receive root trust anchor 32 from another trusted authority, or obtain root trust anchor 32 from a database (not shown) maintained by trusted authority 24.

In response to task 76, a task 78 is performed. At task 78, trusted authority 24 provides root public key 40 of root trust anchor 32 to product developer 26. Trusted authority 24 further retains root private key 38 of root trust anchor 32.

A task 80 is performed by product developer 26 in response to receipt of root public key 40 from trusted authority 24. At task 80, product developer 26 stores root public key 40 in non-changeable memory 54 of product 28.

In response to tasks 78 and 80 or when a determination is made at query task 72 that root trust anchor 32 was not needed, trust anchor assignment process 66 continues with task 74. At task 74, trusted authority 24 produces one of operational trust anchors 37. For purposes of illustration, trusted authority 24 may produce first operational trust anchor 34 at task 74. Trusted authority 24 may generate first operational trust anchor 34 using a key generation algorithm, receive first operational trust anchor 34 from another trusted authority, or obtain first operational trust anchor 34 from a database (not shown) maintained by trusted authority 24.

Following task 74, a task 82 is performed. At task 82, trusted authority 24 attaches a first signature, referred to herein as a root signature 84 (see FIG. 1), to operational public key 44 of first operational trust anchor 34 using root private key 38 of root trust anchor 32. For example, trusted authority 24 may implement a signing algorithm to generate a message digest and encrypt the generated message digest with root private key 38 to form the digital signature, i.e., root signature 84. Root signature 84 is then applied to operational public key 44 to form a signed operational public key 86 (see FIG. 1). As known to those skilled in the art, root signature 84 may take the form of a simple numerical value (normally represented as a string of binary digits). For efficiency, trusted authority 24 may first apply a cryptographic hash function to operational public key 44 before signing, as also known to those skilled in the art.

In response to task 82, a task 88 is performed. At task 88, trusted authority 24 provides signed operational public key 86 to product developer 26. Trusted authority 24 further retains operational private key 42 of first operational trust anchor 34.

A task 90 is performed by product developer 26 in response to receipt of signed operational public key 86 from trusted authority 24. At task 90, product developer 26 loads signed operational public key 86 in first portion 58 of changeable memory 56 within product 28.

Trust anchor assignment process 66 continues with a task 92. At task 92, product developer 26 sends software 22 to trusted authority 24. Software 22 may be written or otherwise generated by product developer 26, and developer 26 deems that is to be authenticated prior to execution.

Upon receipt of software 22, a task 94 is performed. At task 94, trusted authority 24 appends a second signature, referred to herein as an operational signature 96 (see FIG. 1), to software 22 using operational private key 42 of first operational trust anchor 34. As discussed above, trusted authority 24 may implement a signing algorithm to generate a message digest and encrypt the generated message digest with operational private key 42 to form a digital signature, i.e., operational signature 96. Operational siganture 96 is subsequently applied to software 22 to form signed software 98 (see FIG. 1).

Following task 94, a task 100 is performed. At task 100, trusted authority 24 returns signed software 98 to developer 26.

A task 102 is performed by product developer 26 in response to receipt of signed software 98 from trusted authority 24. At task 102, product developer 26 loads signed software 98 in second portion 60 of changeable memory 56 of product 28. Following task 102, trust anchor assignment process 66 exits. Through the implementation of trust anchor assignment process 66, first operational trust anchor 34, having its corresponding operational public key 44 stored in changeable memory 56, may be changed as needed without requiring hardware changes. Whereas root trust anchor 32, having its corresponding root public key 40 stored in non-changeable memory 54, cannot be changed. It will become apparent in the following discussion of trust anchor verification process 68 (FIG. 2) that such a technique can be readily and cost effectively implemented without degrading the strength of authentication being provided and without relying solely on more complex and costly physical tamper mechanisms.

In the situation in which first operational trust anchor 34 is to be replaced, i.e., a negative response to query task 72, second operational trust anchor 36 is produced (task 74). Root signature 84 is attached to operational public key 48 of second operational trust anchor 36 (task 82) and signed operational public key 86 is provided to developer 26 (task 88). Developer 26 loads signed operational public key 86 for second operational trust anchor 36 into changeable memory 56 of product 28 (task 90). Developer subsequently sends software 22 to trusted authority 24 (task 92). Trusted authority 24 appends operational signature 96, now generated using operational private key 46 for second operational trust anchor 36, to software 22 (task 94) and returns signed software 98 to developer 26 (task 100), where it is then loaded into changeable memory 56 within product 28 (task 102). Thus, trust anchor assignment process 66 may readily be implemented to assign multiple trust anchors 30 occurring at the development stage of product 28 and/or software 22, and during an update stage when requesting a new one of operational trust anchors 37.

Referring now to FIGS. 1 and 4, FIG. 4 shows a flowchart of trust anchor verification process 68 of authentication management scheme 64 (FIG. 2). Trust anchor verification process 68 is performed by product 28 to authenticate software 22 prior to its execution in product 28.

Trust anchor verification process 68 begins with a task 104. At task 104, initialization of product 28 occurs. That is, task 104 provides the appropriate signaling to begin the authentication of software 22 installed on product 28.

In response to task 104, a task 106 is performed. At task 106, root signature 84 of signed operational public key 86 stored in changeable memory 56 is evaluated using root public key 40 stored in non-changeable memory 54. More specifically, root signature 84 is decrypted using root public key 40.

A query task 108 is performed in connection with task 106. Query task 108 determines whether root signature 84 is verified. That is, query task 108 determines whether root signature 84 can be decrypted using root public key 40. When root signature 84 cannot be decrypted using root public key 40, process 68 proceeds to a task 110. At task 110, the execution of software 22 is prevented because it has presumably become corrupted. Following task 110, trust anchor verification process 68 exits.

Referring back to query task 108, when root signature 84 is verified, i.e., when root signature 84 can be decrypted using root public key 40, trust anchor verification process 68 proceeds to a task 112.

At task 112, operational signature 96 of signed software 98 stored in changeable memory 56 is evaluated using the now verified first operational public key 44. More specifically, operational signature 96 is decrypted using operational public key 44.

A query task 114 is performed in connection with task 112. Query task 114 determines whether operational signature 96 is validated. That is, query task 114 determines whether operational signature 96 can be decrypted using first operational public key 44. When operational signature 96 cannot be decrypted using operational public key 44, process 68 proceeds to task 110 where the execution of software 22 is prevented due to its presumed corruption, and process 68 exits.

Referring back to query task 114, when operational signature 96 is validated, i.e., when operational signature 96 can be decrypted using operational public key 44, software 22 is authenticated.

When software 22 is authenticated in connection with query task 114, trust anchor verification process 68 proceeds to a task 116. At task 116, the execution of software 22 is enabled and process 68 exits. Consequently, the execution of trust anchor verification process 68 provides authentication of software 22 to the level of root trust anchor 32.

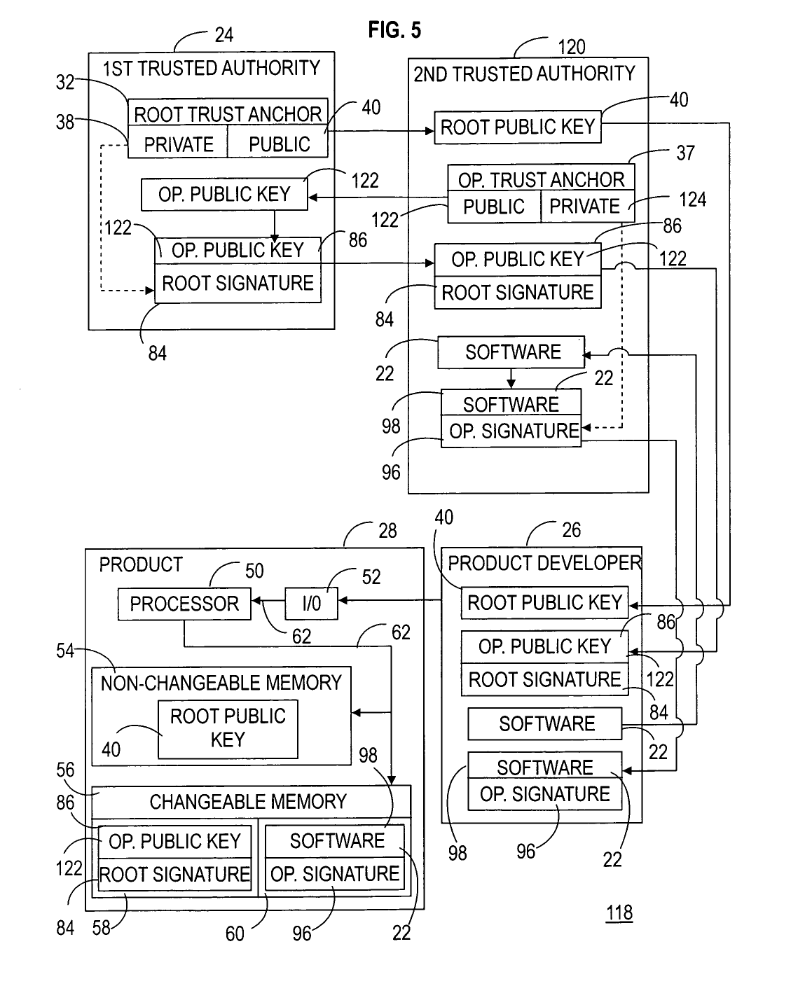

FIG. 5 shows a block diagram of an arrangement 118 in which authentication management of software 22 may be deployed in accordance with an alternative embodiment of the present invention. The methodology described above may be used to transfer the authority to sign software 22 from first trusted authority 24 to a second trusted authority 120 within arrangement 118.

Arrangement 118 includes trusted authority 24 in communication with second trusted authority 120. Second trusted authority 120 is in communication with product developer 26, who is developing product 28 and/or software 22 to be installed into product 28. Trusted authority 24 produces and shares root trusted anchor 32, and second trusted authority 120 is an entity which produces and shares operational trust anchors 37, of which one is shown. As discussed above, operational trust anchor 37 includes a private component, i.e., an operational private key 122, and a public component, i.e., an operational public key 124.

In arrangement 118, trusted authority 24 produces root trust anchor 32, and provides root public key 40 of root trust anchor 32 to second trusted authority 120. Trusted authority 24 further retains root private key 38 of root trust anchor 32. In response to receipt of root public key 40, second trusted authority 120 forwards root public key 40 to product developer 26, who subsequently stores root public key 40 in non-changeable memory 54 of product 28, previously discussed.

Second trusted authority 120 then produces operational trust anchor 37 and provides operational public key 122 to trusted authority 24. Trusted authority 24 attaches root signature 84 to operational public key 122 of operational trust anchor 37 using root private key 38 of root trust anchor 32 to form signed operational public key 86. Trusted authority 24 returns signed operational public key 86 to second trusted authority 120, thereby transferring authority to sign software 22 to second trusted authority 120. Second trusted authority 120 retains operational private key 124 of operational trust anchor 37, and provides signed operational public key 86 to product developer 26 who subsequently loads signed operational public key 86 in first portion 58 of changeable memory 56 within product 28.

Product developer 26 sends software 22 to second trusted authority 120. Upon receipt of software 22, second trusted authority 120 appends operational signature 96 to software 22 using operational private key 124 of operational trust anchor 37 to form signed software 98. Second trusted authority 120 returns signed software 98 to developer 26 who subsequently loads signed software 98 in second portion 60 of changeable memory 56 of product 28. Trust anchor verification process 68 (FIG. 4) may be executed at product 28 to verify root signature 84 and operational signature 96 in order to authenticate software 22, as discussed previously.

In summary, the present invention teaches a method for authentication of software in a product. The method employs multiple trust anchors, one of which is stored in a hard coded location that can be implicitly trusted. The implicitly trusted first trust anchor is used to verify a first signature applied to a second trust anchor that is stored in programmable memory so that it can be changed as often as needed. The verified second trust anchor is used to validate a second signature applied to software. The software is authenticated when the second signature is validated. However, the software is prevented from executing if either of the first and second signatures cannot be validated. Thus, a trust chain is provided where the first trust anchor provides a very high level of assurance that the second trust anchor is authentic, and the second trust anchor then provides a similar level of assurance that the executable software is authentic.

Although the preferred embodiments of the invention have been illustrated and described in detail, it will be readily apparent to those skilled in the art that various modifications may be made therein without departing from the spirit of the invention or from the scope of the appended claims. For example, the process steps discussed herein can take on a number of variations and can be performed in a differing order then that which was presented.

What is claimed is:

1. A method for authentication of software in a product comprising:
storing a first public component of a first trust anchor in non-changeable memory within said product;
attaching a first signature to a second public component of a second trust anchor using a first private component of said first trust anchor to generate said first signature;
loading said second public component with said attached first signature in changeable memory within said product;
appending a second signature to said software using a second private component of said second trust anchor to generate said second signature;
saving said software with said appended second signature in said changeable memory within said product;
utilizing said first public component to verify said first signature; and
upon verification of said first signature, authenticating said software by using said second public component to validate said second signature.

2. A method as claimed in claim 1 further comprising:
producing, at a trusted authority, said first trust anchor;
providing said first public component to a developer of said product; and
retaining said first private component at said trusted authority.

3. A method as claimed in claim 2 further comprising:
producing, at said trusted authority, said second trust anchor; and
performing, at said trusted authority, said attaching operation using said retained first private component.

4. A method as claimed in claim 2 wherein said trusted authority is a first trusted authority, and said method further comprises:
producing, at a second trusted authority, said second trust anchor;
providing said second public component to said first trusted authority for attachment of said first signature;
returning said second public component with said attached first signature to said second trusted authority; and
performing said appending operation at said second trusted authority.

5. A method as claimed in claim 1 further comprising:
producing, at a trusted authority, said second trust anchor;
providing said second public component with said attached first signature to a developer of said product; and
retaining said second private component at said trusted authority.

6. A method as claimed in claim 5 further comprising:
providing said software to said trusted authority from said developer;
performing, at said trusted authority, said appending operation using said retained second private component; and
returning said software with said appended second signature to said developer.

7. A method as claimed in claim 1 wherein said utilizing and authenticating operations are performed by said product.

8. A method as claimed in claim 1 further comprising enabling execution of said software upon validation of said second signature.

9. A method as claimed in claim 1 wherein said utilizing operation comprises:
evaluating, at said product, said first signature using said first public component;
upon invalidation of said first signature, preventing execution of said software.

10. A method as claimed in claim 1 wherein said employing operation comprises:
evaluating, at said product, said second signature using said second public component; and
upon invalidation of said second signature, preventing execution of said software.

11. A method as claimed in claim 1 further comprising:
replacing said second trust anchor with a third trust anchor;
utilizing said first public component to verify a third public component of said third trust anchor; and
upon verification of said third public component, employing said third public component to authenticate said software prior to execution of said software.

12. A method as claimed in claim 11 wherein said replacing operation comprises:
attaching said first signature to said third public component of said third trust anchor using said first private component;
loading said third public component with said attached first signature in said changeable memory within said product;
appending a third signature to said software using a third private component of said third trust anchor; and
saving said software with said appended third signature in said changeable memory within said product.

13. A system within a product for authenticating executable software comprising:
non-changeable memory for storing a first public component of a first trust anchor;
a first changeable memory portion for storing a second public component of a second trust anchor, said second public component having an attached first signature, said first signature being generated using a first private component of said first trust anchor;
a second changeable memory portion for storing said software having an appended second signature, said second signature generated using a second private component of said second trust anchor; and
a processor in communication with each of said non-changeable memory, said first changeable memory portion, and said second changeable memory portion, said processor utilizing said first public component to verify said first signature and using said second public component to validate said second signature, and said processor further preventing execution of said software upon invalidation of either of said first and second signatures.

14. A system as claimed in claim 13 further comprising external path means in communication with said non-changeable memory for receiving said first public component from a trusted authority.

15. A system as claimed in claim 13 further comprising external path means in communication with said first changeable memory portion for receiving said second public component with said attached first signature from a trusted authority.

16. A system as claimed in claim 13 further comprising external path means in communication with said second changeable memory portion for providing said software to a trusted authority and receiving said software with said appended second signature from said trusted authority.

17. A system as claimed in claim 13 further comprising external path means in communication with said first changeable memory portion for receiving a third public component of a third trust anchor from a trusted authority and storing said third public component in said first changeable memory portion, said third public component having said attached first signature, and said external path means being in communication with said second changeable memory portion for providing said software to said trusted authority and receiving said software with an appended third signature from said trusted authority and storing said software with said appended third signature in said second changeable memory portion, said third signature being derived using a third private component of said third trust anchor.

18. A method for authentication management of software within a product comprising:
producing, at a trusted authority, a first trust anchor and a second trust anchor;
providing a first public component of said first trust anchor to a developer of said product for storage in non-changeable memory within said product;
attaching, at said trusted authority, a first signature to a second public component of said second trust anchor using a first private component of said first trust anchor to generate said first signature;
forwarding said second public component with said attached first signature to said developer for storage in changeable memory within said product;
appending, at said trusted authority, a second signature to said software using a second private component of said second trust anchor to generate said second signature;
supplying said software with said appended second signature to said developer for storage in said changeable memory within said product;
utilizing said first public component to verify said first signature; and
upon verification of said first signature, authenticating said software by using said second public component to validate said second signature.

19. A method as claimed in claim 18 further comprising sending said software to said trusted authority from said developer, and said supplying operation returns said software following said appending operation.

20. A method as claimed in claim 18 further comprising enabling execution of said software upon validation of said second signature.

21. A method as claimed in claim 18 wherein said utilizing operation comprises:
evaluating, at said product, said first signature using said first public component;
upon invalidation of said first signature, preventing execution of said software.

22. A method as claimed in claim 18 wherein said authenticating operation comprises:
evaluating, at said product, said second signature using said second public component; and
upon invalidation of said second signature, preventing execution of said software.

23. A method as claimed in claim 18 further comprising:
replacing said second trust anchor with a third trust anchor;
utilizing said first public component to verify a third public component of said third trust anchor; and
upon verification of said third public component, employing said third public component to authenticate said software prior to execution of said software.
